(19) United States
(12) Patent Application Publication
(10) Pub. No.: US 2006/0206695 A1
(43) Pub. Date: Sep. 14, 2006

(54) Data movement within a processor

(76) Inventor: Jonah Proujansky-Bell, Lexington, MA (US)

Correspondence Address: O'Shea, Getz & Kosakowski, P.C., Suite 912, 1500 Main Street, Springfield, MA, 01115, US

(21) Appl. No.: 11/143,876

(22) Filed: Jun. 2, 2005

Related U.S. Application Data
(60) Provisional application No. 60/660,630, filed on Mar. 11, 2005.

(51) Int. Cl. G06F 9/44

(52) U.S. Cl. 712/221

(57) ABSTRACT

A processor, e.g., a VLIW processor, may include two separate execution units, a first execution unit may have a general-purpose register file and an arithmetic logic unit. The register file may source operands to the ALU, and the result of the ALU operation may be stored in the register file or an accumulator. A second execution unit may include instruction control logic that executes an instruction which causes data to be moved through a data path within the first execution unit, e.g., from the ALU or accumulator to the register file, or to and/or from the execution unit. Thus, for example, the first execution unit performs a multiplication operation while the second execution unit moves the results of a multiplication operation (e.g., the most recent multiplication operation) to the register file. This avoids the operation-performing execution unit from expending instruction cycles on data movement operations, which reduces the number of software instruction cycles required to implement the overall logical function, thereby increasing processor performance.

### PRIORITY INFORMATION

This application claims priority from U.S. provisional patent application Ser. No. 60/660,630, filed Mar. 11, 2005, which is hereby incorporated by reference.

### BACKGROUND OF THE INVENTION

This invention relates in general to processors, and in particular to a processor execution unit that executes an instruction which causes a movement of data within another separate execution unit.

It is known in the art to use a very long instruction word (“VLIW”) processor architecture that includes two or more separate execution units which each decodes and executes a portion of a single instruction word. Each execution unit within the VLIW processor typically executes its respective portion of an instruction word simultaneously in parallel with the other execution units.

All processors and many execution units have one or more data storage elements that store or accumulate the results of various types of logical or arithmetic operations performed by the processor or execution unit, for example, multiplication, division or add operations. The data storage element may also accumulate the summation of multiply-add or multiple-subtract instructions. The content of the accumulator may be moved by a “move-from-accumulator” instruction to a general-purpose register file or to another data storage element within the execution unit for further processing. In the prior art, the execution unit that performed the multiplication operation to an accumulator also executed the instructions that moved the data from the accumulator to another data storage element such as a general-purpose register file.

Some VLIW processors include an execution unit that is specialized for multiplication and move-from-accumulator operations as well as another, separate execution unit that performs loads of source data from memory and stores of resulting data to memory. For some software application programs that are run on such a VLIW processor, the execution unit within the VLIW processor that performs the multiplication operations performs such a large number of the multiplication operations and associated move-from-accumulator operations that the separate execution unit within the VLIW processor that typically executes loads and stores operations is caused to simultaneously sit idle and execute “no-op” instructions while the multiplication operations and move-from-accumulator operations are being completed by the first execution unit. Execution of the no-op instructions is indicative of an imbalance in the workload between the two execution units within the VLIW processor.

What is needed is an arrangement of at least two separate execution units in which an instruction executed by one of the execution units causes data to be moved between data storage elements in another one of the execution units, to thereby allow for flexibility in spreading out the execution of instructions between different execution units in a manner that reduces the number of clock cycles wasted by otherwise having an execution unit execute no-op instructions.

### SUMMARY OF THE INVENTION

In an embodiment of a processor, for example a VLIW processor, which may include at least two separate execution units, a first execution unit may have a data storage element such as a general-purpose register file, along with one or more logical functional units or data processing elements, such as an arithmetic logic unit or a multiplier. The register file may source one or more operands to the logical functional unit, and the result of the operation may be stored in the register file or in a separate data storage element such as an accumulator. The first execution unit may also include instruction control logic that decodes all or part of an instruction to control the movement, transformation or processing of data within the first execution unit.

A second execution unit within the VLIW processor may be any type of execution unit separate from the first execution unit. The second execution unit includes instruction control logic that executes an instruction which causes or allows data to be moved through a data path within the first execution unit, for example from the logical functional unit or an accumulator to the general-purpose register file.

In one embodiment, the logical functional unit of the first execution unit may be a multiplier, and the specific instruction executed by the second execution unit may be a “move data” type of instruction which moves the result of a multiplication operation from the multiplier to the register file. In this embodiment the first execution unit is performing a multiplication operation while the second execution unit is moving the results of a multiplication operation to the register file. The multiplication operation and the move-from-accumulator operation, while related, are each typically performed by its own separately executed instruction. Also, while the first execution unit is performing the multiplication operation, the second execution unit is moving the results of a previous multiplication operation, i.e., the most recent multiplication operation.

In an alternative embodiment, the first execution unit may include one or more additional data storage elements, such as accumulator registers, which store the results of the multiplication operations performed by the arithmetic logic unit. The second execution unit may execute an instruction, such as a “move from accumulator” instruction, which moves the data stored in the accumulator to the general-purpose register file.

A corresponding method for moving data within a processor may include a step of providing operand source data from a first data storage element, such as a general-purpose register file within a first execution unit, to a logical functional unit, such as an arithmetic logic unit, also within the first execution unit. A step may be performed in which an operation on the source data is performed in the logical functional unit and the result of that operation is stored in the general-purpose register file. The operation may be, for example, an arithmetic operation such as a multiplication operation. An instruction may be executed in a second execution unit that causes the operation result data in the logical functional unit to be moved to the data storage element within the first execution unit.

In an alternative embodiment of the method, the operation result data in the logical functional unit may be provided to a second data storage element within the first execution unit. The second data storage element may be one or more accumulator registers. Whether the logical functional unit moves the operation result data to the register file or to the accumulator typically depends on the instruction set of the execution unit that performs the operation. In this alternative embodiment, a step may be performed in which an instruction in the second execution unit is executed that causes the operation result data in the accumulator to be moved to the register file within the first execution unit.

By having one execution unit perform a logical functional (e.g., arithmetic) operation, such as a multiplication operation with a large number of repetitive operations on the operands, and having another separate execution unit execute an instruction that moves the operation result data from either the logic functional unit or the accumulator to the register file or some other data storage element within the execution unit that performs the operation, an improvement in performance can be achieved over prior art processors. Specifically, the apparatus and method reduce the total number of instruction clock cycles required to perform the entire operation, which includes the move data instructions, thereby improving the overall processor execution time for the particular software application.

Thus, in the apparatus and method, an identical function (e.g., move data from the accumulator) may be performed by either the first execution unit or the second execution unit. Overall processor improvements result from having the second execution unit perform the identical function that may also be performed by the first execution unit.

The apparatus and method cause a processor, such as a VLIW processor, to execute an instruction on one execution unit which moves data indicative of the result of the operation to the register file on a separate execution unit, to thereby avoid the operation-performing execution unit from expending instruction cycles on the data movement operation. This can reduce the number of software instruction cycles required to implement the overall logical function and thereby increase the performance of the processor for this function.

These and other objects, features and advantages of the present invention will become more apparent in light of the following detailed description of preferred embodiments thereof, as illustrated in the accompanying drawings.

### BRIEF DESCRIPTION OF THE DRAWINGS

The sole FIGURE is a block diagram of a processor having two execution units that perform an operation and move data indicative of a result of that operation.

### DETAILED DESCRIPTION OF THE INVENTION

Referring to the sole FIGURE, there illustrated is an embodiment of a processor 10, such as a VLIW processor, having a first execution unit 14 which may include a data storage element 18, such as for example a general purpose register file. The execution unit 14 may also include a logical functional unit 22, such as an arithmetic logic unit (“ALU”), which may for example be a multiplier, and one or more accumulator registers 26 that may store the results of the multiplication operations performed by the ALU 22. The register file 18 may provide one or more operands on a data bus 30 to the multiplier 22, which multiplies these operands and provides the result of the multiplication operation on a data bus 34 to the accumulator 26, or back to the register file 18 through a first multiplexer (“MUX”) 38 and a data bus 42.

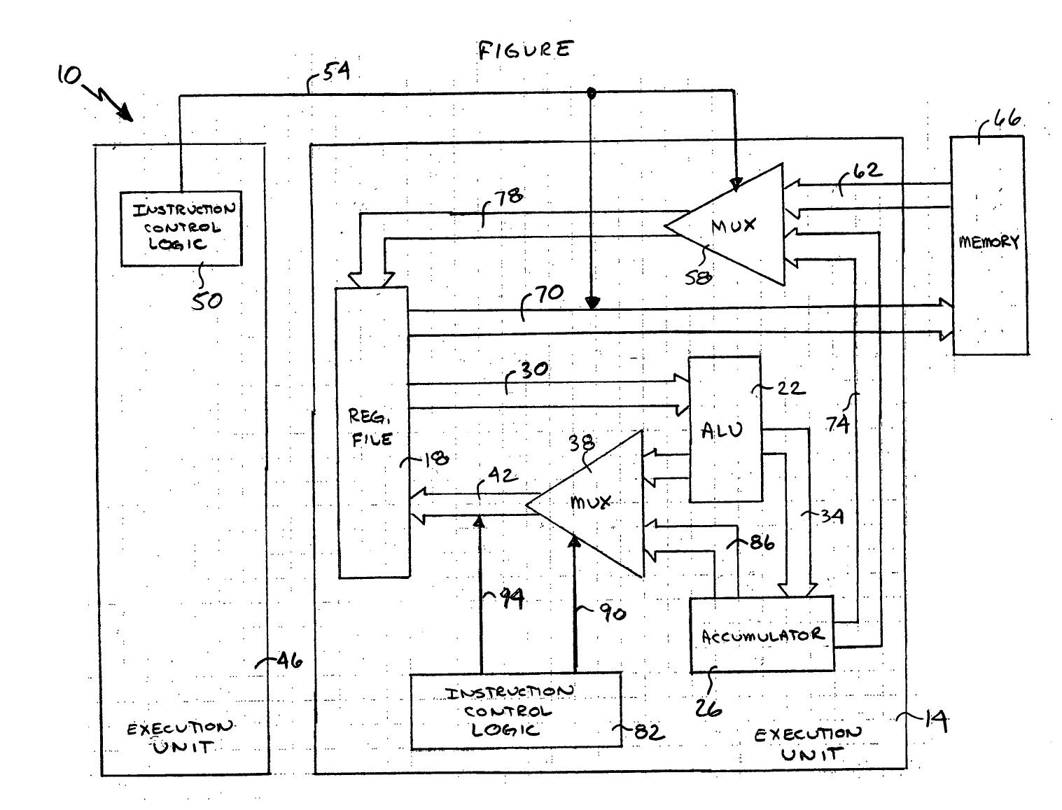

A second execution unit 46 that is separate from the first execution unit 14 may include instruction control logic 50. This logic 50 may execute an instruction or part of an instruction word that causes data to be moved from the multiplier 22 or the accumulator 26 to the register file 18, this data being indicative of the result of the multiplication operation. The second execution unit 46 may be any type of execution unit that is autonomous and separate from the first execution unit 14. The second execution unit 46 may typically perform other operations such as loads and stores as well as flow control operations such as branches. Thus, as used herein, the term “execution unit” may be understood to refer to a machine or part of a machine that comprises, without limitation, one or more data processing elements or logical functional units, such as an ALU or multiplier 22. An “execution unit” may also include logic 50 that decodes all or part of an instruction for the purpose of controlling the movement, transformation or processing of data, and at least one data storage element 18, 26. A “processor” may be understood to refer to one or more execution units, an example being a VLIW processor 10 of the embodiment of FIG. 1 having two execution units 14, 46, each execution unit decoding part of an instruction word.

The second execution unit 46 may provide a signal indicative of the “move data” instruction from the instruction control logic 50 on a signal line 54 connected to a control input of a second multiplexer (“MUX”) 58. A first data input of the MUX 58 is connected to a data bus 62 that provides data as part of a load data operation from a device such as a memory 66. The memory 66 may also receive data on a data bus 70 directly from the register file 18 as part of a store data operation. The memory 66 may be external to the first and second execution units 14, 46, yet still be within the processor 10, or the memory 66 may be separate from the processor 10.

A second data input of the MUX 58 is connected to a data bus 74 connected to the accumulator 26. The output of the multiplexer MUX 58 is provided on a data bus 78 connected to the register file 18. The MUX 58 enables the second execution unit 46 to perform instructions that operate on data from sources external or separate from the unit 46, such as loading data into the first execution unit 14 from the memory 66, as well instructions that operate on data, the source of which is in the first execution unit 14 such as the accumulator 26.

The data bus 70 between the register file 18 and the memory 66 may also be under control of the second execution unit 46, in that the instruction control logic 50 within the second execution unit 46 may execute an instruction that stores data from the register file 18 to the memory 66. This control may be indicated by the signal line 54 also being connected to the data bus 70. Thus, the instruction control logic 50 in the second execution unit 46 may control the typical “loads and stores data” operations to control movement of data within the first execution unit 14.

The second execution unit 46 may execute a “move-from-accumulator” instruction initiated from its instruction control logic 50 that causes the signal line 54 to select the second data input of the multiplexer 58 to pass the output data from the accumulator 26 to the multiplexer output and on to the register file 18. One or more transformation steps on the accumulator data may be performed as part of the execution of the move-from-accumulator instruction prior to the data being stored in the register file 18. These transformation steps may include, for example, round, shift and saturate. These operations may be performed on the full extent of the accumulator data or on just a portion of that data. The transformation operations may occur as a result of an instruction performed by the instruction control logic 50 within the second execution unit 46.

In certain software applications that include many multiplication operations, the first execution unit 14 containing the multiplier 22 will be relatively more occupied executing instructions as compared to the second execution unit 46 which may be primarily performing the loads and stores operations. Thus, this second execution unit 46 has less to do in the way of instruction execution and it will typically execute no-op instructions when idle. The apparatus and method have the advantage of off loading instructions from the first execution unit 14 to the second execution unit 46. This enables programmers and compilers to better balance the workload between the two execution units 14, 46, to thus speed up the overall performance of the processor system that includes the two execution units 14, 46.

The first execution unit 14 may also include instruction control logic 82 that implements, for example, the instructions executed by the arithmetic logic unit 22. For example, the instruction control logic 82 may issue instructions, that cause the multiplier 22 to perform the multiplication operations. A second data bus 86 may be connected from the accumulator 26 to an input of the first MUX 38. The instruction control logic 82 may execute an instruction that causes the data in the accumulator 26 to pass on the bus 86 through the first MUX 38 and on to the register file 18 on the data bus 42. This control is illustrated by the signal line 90 connected from the instruction control logic 82 to a control input of the MUX 38. The instruction control logic 82 may also execute control over the various data buses in executing its instructions to move data within the first execution unit 14. In an example, a signal line 94 is connected from the instruction control logic 82 to the data bus 42. Also, in this embodiment the register file 18 may have two write ports to allow each execution unit 14, 46 to move data from either the ALU 22 or the accumulator 26 to the register file 18.

Thus, a feature of the apparatus and method is that the first execution unit 14 has separate data paths for certain operations controlled by the first execution unit 14 and for other certain operations controlled by the second execution unit 46. As used herein, the term “data path” may be understood to refer to any path for the routing of data, the path being controlled by a single execution unit, and by which path data can be moved from a data storage element to another data storage element. The data path does not itself comprise any data storage elements. As described and illustrated herein, besides the various data buses 30, 34, 42, 62, 70, 74, 78, 86, an example of a data path may also include the logical functional unit, for example the ALU or multiplier 22. An “ALU” may be understood to refer to a data path that performs logical or arithmetic operations on one or more data elements, typically within a single clock cycle. Logical operations may include non-arithmetic operations. A “multiplier” may be understood to refer to a data path that performs multiplication of one or more data elements, typically over the course of more than one clock cycle, by using a pipeline of data transforming logic separated by intermediate registers that are not data storage elements because their values are automatically overwritten in the next valid clock cycle regardless of software design.

Further, a “data storage element” may be understood to refer to any element within an execution unit capable of retaining one or more data values from one clock cycle to the next until it is overwritten with a new data value as a result of a software instruction. Examples include flip-flops, latches and random access memory. A “general-purpose register file” may be understood to refer to a plurality of data storage elements, typically the source of data to an ALU or multiplier, and typically the destination of data resulting from operations in the ALU. An “accumulator” may be understood to refer to one or more data storage elements with the ability to add or subtract another data element from the data stored in the data storage element, and it is typically used as the target of the results of the multiplier operations.

Another embodiment of the apparatus and method is for the situation where the second execution unit 46 may have a greater work load in performing various loads, stores and branches operations, as compared the first execution unit 14 in performing various logical (e.g., arithmetic) functions. As such, the first execution unit 14 may take on some of the work load from the second execution unit 46 by performing an identical function, for example, a load, store and/or branch operation, that would normally be performed by the second execution unit 46. This way, there is a better balance of the work load between the two execution units 14, 46. The apparatus and method for achieving this alternative embodiment should be apparent to one of ordinary skill in the art in light of the teachings herein.

The apparatus and method significantly improve the performance of a processor, for example a VLIW processor, having an arithmetic logic unit and data storage element architecture, such as a multiplier-accumulator architecture, when running many software applications that intensively use the results of the multiplication operations; that is, software applications that have many multiplication operations and many associated move-from-accumulator operations. Some typical applications of the apparatus and method include, for example and without limitation, those associated with video encoding/decoding, including discrete cosine transforms, inverse discrete cosine transforms, sub-pixel interpolation filtering, and deblocking pixel filtering. Also included are discrete and fast Fourier transforms for audio coding.

The apparatus and method have application and benefit in video coding and decoding techniques for high definition television (HDTV). HDTV has rigorous requirements for pixel processing. In such systems, the pixel processing is typically carried out by a system having a plurality of processors, such as a VLIW processor with multiple execution units operating simultaneously in “lock step”. These VLIW digital signal processors (“DSPs”) invariably have intensive multiply and associated accumulate result operations. One execution unit within the VLIW processor may perform the multiplication operations while a second execution unit within the VLIW processor may perform the loads and stores operations. The apparatus and method provide a marked increase in overall speed of execution of the operations performed by the execution units within the VLIW processors in HDTV and other applications.

Although the present invention has been illustrated and described with respect to several preferred embodiments thereof, various changes, omissions and additions to the form and detail thereof, may be made therein, without departing from spirit and scope of the invention.

What is claimed is:

1. Processor apparatus, comprising a plurality of execution units, a first one of the execution units having a data path that is controlled by a second one of the execution units.

2. The processor apparatus of claim 1, where the first one of the execution units includes a general-purpose register file and an accumulator, where the data path reads source data from the general-purpose register file and writes data to the accumulator.

3. The processor apparatus of claim 1, where the first one of the execution units includes a general-purpose register file, where the data path sources data from the general-purpose register file and writes data to the general-purpose register file.

4. The processor apparatus of claim 1, where the data path comprises an arithmetic logic unit.

5. The processor apparatus of claim 4, where the arithmetic logic unit writes data to a general-purpose register file.

6. The processor apparatus of claim 1, where the data path comprises a multiplier.

7. The processor apparatus of claim 6, where the multiplier writes data to a general-purpose register file.

8. The processor apparatus of claim 6, where the multiplier writes data to an accumulator.

9. The processor apparatus of claim 1, where the second execution unit controls a data path that reads data from outside of the first execution unit and writes data to a data storage element within the first execution unit.

10. The processor apparatus of claim 1, where the second execution unit controls a data path that reads data from a data storage element within the first execution unit and writes data to outside of the first execution unit.

11. The processor apparatus of claim 1, where a function performed by the data path is identical to a function performed by the first execution unit.

12. The processor apparatus of claim 11, where the data path reads source data from a general-purpose register file and writes data to an accumulator.

13. The processor apparatus of claim 11, where the data path reads source data from a general-purpose register file and writes data to a general-purpose register file.

14. The processor apparatus of claim 11, where the data path comprises an arithmetic logic unit.

15. The processor apparatus of claim 11, where the data path comprises a multiplier.

16. The processor apparatus of claim 11, where the identical function is performed by the execution of a plurality of instructions by the second execution unit.

17. The processor apparatus of claim 11, where the identical function is performed by the execution of a plurality of instructions by the first execution unit.

18. The processor apparatus of claim 11, where the identical function is performed by a single instruction on the second execution unit and a single instruction on the first execution unit.

19. A method for moving data within a processor, comprising the steps of:
providing first and second execution units, the first execution unit having a data path for moving data within at least one data storage element of the first execution unit; and
controlling the data path of the first execution unit through control executed by the second execution unit.

20. The method of claim 19, where the at least one data storage element comprises a general-purpose register file and an accumulator, where the step of controlling the data path comprises the step of reading source data from the general-purpose register file and writing data to the accumulator.

21. The method of claim 20, where the data path comprises an arithmetic logic unit.

22. The method of claim 20, where the data path comprises a multiplier.

23. The method of claim 19, where the at least one data storage element comprises a general-purpose register file, where the step of controlling the data path comprises the step of reading source data from the general-purpose register file and writing data to the general-purpose register file.

24. The method of claim 23, where the data path comprises an arithmetic logic unit.

25. The method of claim 23, where the data path comprises a multiplier.

26. The method of claim 19, where the control executed by the second execution unit comprises the step of controlling the data path to read data from outside of the first execution unit and to write data to at the least one data storage element within the first execution unit.

27. The method of claim 19, where the control executed by the second execution unit comprises the step of controlling the data path to read data from the at least one data storage element within the first execution unit and to write data to outside of the first execution unit.

28. The method of claim 19, where a function performed by the data path is identical to a function performed by the first execution unit.

29. The method of claim 28, where the function performed by the data path comprises the steps of reading source data from a general-purpose register file and writing data to an accumulator.

30. The method of claim 28, where the function performed by the data path comprises the steps of reading source data from a general-purpose register file and writing data to a general-purpose register file.

31. The method of claim 28, where the data path comprises an arithmetic logic unit.

32. The method of claim 28, where the data path comprises a multiplier.

33. The method of claim 28, where the identical function is performed by the execution of a plurality of instructions by the second execution unit.

34. The method of claim 28, where the identical function is performed by the execution of a plurality of instructions by the first execution unit.

35. The method of claim 28, where the identical function is performed by a single instruction on the second execution unit and a single instruction on the first execution unit.
